(19) United States
(12) Patent Application Publication
(10) Pub. No.: US 2006/0177549 A1
(43) Pub. Date: Aug. 10, 2006

(54) Food composition

(76) Inventors: John Van De Sype, Semmerzake (BE); Mac Heirman, Kortrijk (BE)

Correspondence Address: CARGILL, INCORPORATED, LAW/24, 15407 MCGINTY ROAD WEST, WAYZATA, MN, 55391, US

(21) Appl. No.: 10/564,492

(22) PCT Filed: Jul. 24, 2003
(86) PCT No.: PCT/US03/23309

§ 371 Date: Jan. 12, 2006

(51) Int. Cl. A21D 2/16

(52) U.S. Cl. 426/330

(57) ABSTRACT

There are disclosed compositions containing specified lecithins that are suitable for many applications, particularly as a calf milk replacer.

### CROSS REFERENCE TO RELATED APPLICATION

This application is a continuation-in-part application of U.S. application Ser. No. 10/202,294 that was filed with the United States Patent and Trademark Office on Jul. 23, 2002.

### FIELD OF THE INVENTION

The present invention relates to food compositions containing specified lecithins suitable for many applications such as calf milk replacers.

### BACKGROUND OF THE INVENTION

Lecithin is used as an emulsifier in numerous applications including food and feed. Lecithin is added to animal feed to achieve an improved nutritive value of the feed or to achieve a better emulsion and dispersion in the case of liquid feed. The emulsifying properties of lecithin are not only exploited in livestock production by inclusion of lecithin in dry rations but also in areas where animals are given liquid feed containing a large proportion of fat. These are primarily milk replacements for calves and sow milk substitutes for piglets. The function of lecithins is to produce the finest possible dispersion of the fat in the ready prepared liquid feed. The fine dispersion results in improved digestibility of the fat by the animals. In addition, the lecithin exhibits a favorable effect on the settling of insoluble constituents in a liquid feed.

### SUMMARY OF THE INVENTION

The compositions according to the invention are oil-in-water emulsions. The present invention relates to a composition suitable for use as a calf milk replacer comprising from about 1 wt. % to about 30 wt. % fat phase, from about 70 wt. % to about 99 wt. % aqueous phase, and from about 0.05 wt. % to about 5.0 wt. % of a membrane separated lecithin having a ratio of alkali metals to alkaline earth metals ranging from greater than 0 to about 10, preferably greater than 0 to about 5. In another embodiment, the composition comprises from about 1 wt. % to about 30 wt. % fat phase, from about 70 wt. % to about 99 wt. % of an aqueous phase, and from about 0.05 wt. % to about 5.0 wt. % of a lecithin having a ratio of alkali metals to alkaline earth metals ranging from about 1.6 to about 3.0, preferably about 1.8 to about 2.8. The fat phase may comprise any vegetable and/or animal oils or fats that are natural or modified, for example, chemically, physically or enzymatically.

### DETAILED DESCRIPTION OF THE INVENTION

The compositions according to the invention are oil-in-water emulsions. The present invention relates to a composition suitable for use as a calf milk replacer comprising from about 1 wt. % to about 30 wt. % fat phase, from about 70 wt. % to about 99 wt. % aqueous phase, and from about 0.05 wt. % to about 5.0 wt. % of a membrane separated lecithin having a ratio of alkali metals to alkaline earth metals ranging from greater than 0 to about 10, preferably greater than 0 to about 5. In another embodiment, the composition comprises from about 1 wt. % to about 30 wt. % fat phase, from about 70 wt. % to about 99 wt. % of an aqueous phase, and from about 0.05 wt. % to about 5.0 wt. % of a lecithin having a ratio of alkali metals to alkaline earth metals ranging from about 1.6 to about 3.0, preferably about 1.8 to about 2.8. The fat phase may comprise any vegetable and/or animal oils or fats that are natural or modified by interesterification, hydrogenation, fractionation, and the like.

The composition of the present invention can be produced by any known methods. For example, a fat phase is prepared comprising an oil and a lecithin product of the present invention. The fat phase is mixed with an aqueous phase.

In the present composition, the fat phase of about 1 wt. % to about 30 wt. % of any oil is used. In particular, the fat phase suitable for use is about 2 wt. % to about 15 wt. %. Any oil, which may be solid or liquid at ambient temperature, can be used in the present food composition. Suitable vegetable oils for use include, for example, soybean oil, sunflower oil, rapeseed oil, cottonseed oil, olive oil, corn oil, ground nut oil, safflower oil, linola oil, linseed oil, palm oil, coconut oil, all of which may be partially or completely hydrogenated or modified otherwise, and mixtures thereof. Particularly useful are soybean oil and partially hydrogenated soybean oil. Suitable oils of animal origin for use include, for example, butterfat and fish oil.

In addition to the above-mentioned ingredients, the fat phase may optionally contain further fat-soluble ingredients. Examples of these materials are colorants, fat-soluble flavors and vitamins, fat soluble emulsifiers and stabilizers, and the like.

The optional aqueous phase of the present composition may comprise water and optionally contain further water-soluble ingredients suitable for use. Examples of these materials are proteins, flavors which are water soluble, emulsifiers, thickeners, salt, sugars, dairy ingredients, preservatives, and the like.

In the present composition, about 0.05 wt. % to about 5.0 wt. % of a lecithin having an acetone soluble content of about 35 wt. % to about 40 wt. % and a ratio of greater than 0 to about 10 of alkali metals to alkaline earth metals in monovalent or divalent ionic state, is used. In particular, a membrane separated lecithin having a ratio of 1.9 alkali metals to alkaline earth metals is used.

The lecithin products of the present invention are in a first embodiment described as membrane separated lecithin having a ratio of alkali metals to alkaline earth metals ranging from greater than 0 to about 10, and in another embodiment ranging from greater than 0 to about 5. In a second embodiment the lecithin products of the present invention are described as lecithins having a ratio of alkali metals to alkaline earth metals ranging from about 1.6 to about 3.0, and in another embodiment ranging from about 1.8 to about 2.8.

In determining the content of the alkali metals and alkaline earth metals of the lecithin product, the following test procedure is used:

Elemental Analysis Standard Procedure SRC

Elemental analysis was performed by Inductively Coupled Plasma-Emission Spectroscopy (ICP-ES) with target elements of aluminum, calcium, chromium, iron, lead, magnesium, nickel, potassium, phosphorus, silicon, sodium, and zinc. This analysis was performed according to the American Oil Chemists' Society (AOCS) Official Method Ca 20-99. Each sample was weighed on an analytical balance to the nearest 0.0001 g. Because of the range of concentration, two dilution levels are required. Approximately 0.8 g of sample was weighted out and recorded. To the sample approximately 4.2 g of kerosene was weighted and recorded. The sample/kerosene mixture was vortexed until the sample is completely dissolved. Approximately 4.2 g mineral oil was added to the sample/kerosene solution and recorded. This concentration is used to analyze the lower level elements, Al, Cr, Fe, Pb, Na, Ni, Si, and Zn. For the higher concentration elements, Ca, Mg, P and K, another dilution is made by taking approximately 0.5 g of the first dilution, recording the weight, and adding approximately 9.5 g of a 50/50 kerosene/mineral oil and record the total weight. All of the final dilutions are mixed until homogeneous. The samples are placed into a heated, 40° C., sample hot plate along with the standards and allowed to come to temperature, approximately 10 minutes, prior to the introduction into the ICP. Samples were run in triplicate.

Calculation:

The ICP data is reported typically as ppm calcium, magnesium, potassium, sodium and phosphorous, along with other metals. The ppm values are divided by the atomic weight of the respective element (Ca:40, K:39, P:31 and Mg:24) and the atomic equivalents are used to calculate the ratio of monovalent to divalent (alkali metals to alkaline earth metals).

The lecithin products of the present invention may be prepared by any suitable manner. For example, a vegetable oil miscella may be passed through a membrane, preferably polymeric or semi-permeable, to obtain a retentate and a permeate. The lecithin products are in the retentate. Exemplary of such methods are those appearing in U.S. Pat. No. 6,207,209 to Jirjis, et al.; U.S. Pat. Nos. 4,496,498 and 4,533,501 to Sen Gupta. Specific examples describing the preparation of lecithin products of the invention are provided as follows:

### Example A

Two samples of miscella were prepared by using the present technique. Miscella samples were obtained from two different oil seeds plants.

A membrane was conditioned and used for removing phospholipids from each of the two samples of miscella. The membrane purchased was a PAN membrane from Osmonics, Inc. The membrane can be characterized as having an average pore size of 0.3 micron, and in the form of a spiral wound 25 inch×40 inch membrane element. The membrane was conditioned by soaking the membrane in an intermediate solvent (propanol) for 24 hours. Then the membrane was soaked in mixture of intermediate solvent (propanol) and extraction solvent (hexane) for 24 hours. Finally, the membrane was soaked in extraction solvent (hexane) for 24 hours.

The two samples of miscella were individually processed. For the soybean oil miscella, the test was conducted at retentate concentration of 10× of the feed concentration and the permeate rate of 10× concentration was 100 liter/hour m². For the corn miscella, the test was conducted at retentate concentration of 7.4× of the feed at a permeate rate of 80 liter/hour m².

### Example B

Samples of soybean oil miscella were taken on different days and were treated by using the present technique.

Spiral wound 8 inch×40 inch QX membranes were purchased from Osmonics, Inc. The membranes were conditioned and used for removing phospholipids by soaking them in an intermediate solvent (100% isopropanol) for 12 hours. At 6 hours, the intermediate solvent was recirculated at a flow rate of 15 m3/hr per element and forced through the membrane pores for about 15 minutes using a pump (this recirculation or forcing through is referred to as “forced permeation” for purposes of this Example B). Then the resulting membrane was soaked in a 50:50 mixture of intermediate solvent (100% isopropanol) and extraction solvent (100% commercial hexane) for 12 hours. After 6 hours this soaking included recirculation at a flow rate of15 m³/hour per element and forced permeation for about 15 minutes. Finally, the resulting membranes were soaked in extraction solvent (100% commercial hexane) for 12 hours, also with recirculation and forced permeation of the extraction solvent at 6 hours for about 15 minutes with 15 m³/hour recirculation flow. The resulting membranes treated with this process are “conditioned membranes” for purposes of this Example B.

The soybean miscella containing about 75 wt. % hexane, 24.3 wt. % crude oil, and 0.7 wt. % phospholipids, was passed through the first conditioned membrane at a trans-membrane pressure of 4 Kgf/cm² at a rate of 0.6 m³/hour per element. The resulting retentate stream had about 7 wt. % phospholipids and 23 wt. % oil (i.e., the test was conducted at retentate concentration of 10× of the feed concentration). Excess hexane was added to this retentate in the proportion of 2 portions of hexane to 1 portion of retentate resulting in a stream containing 88 wt % hexane. This retentate stream was passed through a second conditioned membrane at a trans-membrane pressure of 4 Kgf/cm² at a rate of 0.35 m³/hour per element, resulting in a retentate stream having about 65 wt % hexane, 23 wt. % phospholipids and 12 wt. % oil which is equivalent to lecithin free of hexane with 66% acetone insolubles. This retentate stream was desolventized at a rate of 1800 kg/hour, 95° C. and 260 mmHg absolute pressure. The resulting concentration of hexane was 5%. The retentate stream was further desolventized at a temperature of 110° C. at an absolute pressure of 20 mm Hg and sparge steam of 80 kg/hour by using a stripper to produce 600 kg/hour of lecithin product with less than 5 ppm of hexane.

The compositions according to the present invention shows low creaming compared to the standard, which indicates the composition is a good emulsifier.

The composition suitable for use as a calf milk replacer is supported by the following example. It should be understood that the example is not intended to limit the scope of the invention.

### EXAMPLE

The creaming test was used to determine the emulsifying property of the composition of the present invention suitable for use as a calf milk replacer. A fat phase, representative of the milk composition of a cow, was prepared by mixing 60% refined coconut fat at 50° C. and 40% refined paln oil at 50° C. in a glass beaker. 3.0 grams of membrane separated lecithin having 62 wt. % acetone insolubles and a ratio of 1.9 of alkali metals to alkaline earth metals was placed in a 150-millimeter glass beaker, and 47.0 grams of the fat phase and 5 milligrams of Sudan Red III colorant were added to the glass beaker. The beaker was then placed in a warm water bath to maintain the temperature at 50° C. 400 millimeter of demineralized water at 50° C. was placed in a 600-millimeter glass beaker and the mixture of fat phase and lecithin was added to the water and mixed using a mixer (Ultraturrax comprised of a module by Kinematica GmbH, Switzerland, Type RECO 20T, and a POLYTRON mixer Type PT 10/35 by Kinematica GmbH, Switzerland) for 2 minutes at 9900 rpm, which formed small droplets of an emulsino. This resulting emulsion was poured into a 500-millimeter graduated cylinder. The creaming of a dark red layer at the top of the cylinder was measured every 10 minutes for 1 hour. The results are shown in Table 1.

TABLE 1

| Time (minutes) | Creaming (millimeter) |
|---|---|
| 0 | 0 |
| 10 | 0 |
| 20 | 2 |
| 30 | 3 |
| 40 | 4 |
| 50 | 5 |
| 60 | 7 |

A standard of less than 15 millimeter creaming at 60 minutes indicates a good calf milk replacer. Therefore, the composition of the present invention is suitable for use as a calf milk replacer.

The invention has been described with reference to various specific and illustrative embodiments and techniques. However, one skilled in the art will recognize that many variations and modifications may be made while remaining within the spirit and scope of the invention.

We claim:

1. A composition comprising from about 70 wt. % to about 99 wt. % aqueous phase, from about 1 wt. % to about 30 wt. % fat phase and from about 0.05 wt. % to about 5.0 wt. % of a membrane separated lecithin having a ratio of alkali metals to alkaline earth metals ranging from greater than 0 to about 10.

2. The composition of claim 1 wherein the aqueous phase ranges from about 80 wt. % to about 99 wt. %, and the fat phase ranges from about 1 wt. % to about 20 wt. %.

3. The composition of claim 1 wherein the aqueous phase ranges from about 85 wt. % to about 98 wt. %, and the fat phase ranges from about 2 wt. % to about 15 wt. %.

4. The composition of claim 1 wherein the lecithin has a ratio of alkali metals to alkaline-earth metals ranging from greater than 0 to about 5.

5. The composition of claim 4 wherein the aqueous phase ranges from about 80 wt. % to about 99 wt. %, and the fat phase ranges from about 1 wt. % to about 20 wt. %.

6. The composition of claim 4 wherein the aqueous phase ranges from about 85 wt. % to about 98 wt. %, and the fat phase ranges from about 2 wt. % to about 15 wt. %.

7. A composition comprising from about 70 wt. % to about 99 wt. % aqueous phase, from about 1 to about 30 wt. % fat phase and from about 0.05 to about 5.0 wt. % of lecithin having a ratio of alkali metals to alkaline-earth metals in monovalent or divalent ionic state ranging from about 1.6 to about 3.0.

8. The composition of claim 7 wherein the aqueous phase ranges from about 80 wt. % to about 99 wt. %, and the fat phase ranges from about 1 wt. % to about 20 wt. %.

9. The composition of claim 7 wherein the aqueous phase ranges from about 85 wt. % to about 98 wt. %, and the fat phase ranges from about 2 wt. % to about 15 wt. %.

10. The composition of claim 7 wherein the lecithin has a ratio of alkali metals to alkaline earth metals ranging from about 1.8 to about 2.8.

11. The composition of claim 10 wherein the aqueous phase ranges from about 80 wt. % to about 99 wt. %, and the fat phase ranges from about 1 wt. % to about 20 wt %.

12. The composition of claim 10 wherein the aqueous phase ranges from about 85 wt. % to about 98 wt. %, and the fat phase ranges from about 2 wt. % to about 15 wt. %.
